(19) United States
(12) Patent Application Publication
(10) Pub. No.: US 2008/0183523 A1
(43) Pub. Date: Jul. 31, 2008

(54) Carbon credit workflow system

(75) Inventor: Neal Dikeman, San Francisco, CA (US)

Correspondence Address: H. Michael Brucker Law Corp., Suite 110, 5855 Doyle Street, Emeryville, CA, 94608, US

(73) Assignee: Carbon Flow, Inc.

(21) Appl. No.: 12/009,698

(22) Filed: Jan. 22, 2008

Related U.S. Application Data
(60) Provisional application No. 60/881,901, filed on Jan. 22, 2007.

(51) Int. Cl. G06Q 10/00

(52) U.S. Cl. 705/7

(57) ABSTRACT

A computer-driven, web-based system and method that facilitates the creation and transaction of carbon credits and, more particularly, to a web-enabled software system that facilitates the analysis, calculation, preparation, documentation, data management, workflow management, trading and storage of certified emissions and energy credits or offsets (green credits).

### FIELD OF THE INVENTION

The present invention relates to a computer-assisted, web-based system that facilitates the creation and transaction of carbon credits and, more particularly, to a web-enabled software system that facilitates the analysis, calculation, preparation, documentation, data management, workflow management, trading and storage of certified emissions and energy credits or offsets (green credits).

### Glossary

Because the field of environmental certified credits is an emergent one, terminology to describe the activities, participants and components involved has not yet reached a level of standardization that avoids ambiguity and, thus, for the purposes of this document and to establish a level of certainty in the terminology used herein, the following words and phrases shall have the following meanings throughout.

### Benchmarking

The process of comparing the metric of one quantity or process to the metric of a standard for that process or quantity or to a related process or quantity.

e-Record/Project Documentation

A limited access database of elements of one or more (typically more) green projects and including the documentation, communications, data, and calculations used during the workflow of a project, including the creation, design, validation, certification, monitoring and settlement of green credits.

### Element

All or some of the data entered in a field of a Template.

### Element Source

The person or entity responsible for entering data in a Template and a reference to the origin(s) of that data which can include a link to the full data set from which the data was extracted or merely a reference to “user,” and anything there between.

### Emission Allowances (Allowances)

The Protocol-agreed ‘caps’ or quotas on the maximum amount of Greenhouse gases for developed and developing countries listed in its Annex I[4]. In turn, these countries set quotas on the emissions of installations run by local business and other organizations, generically termed ‘operators’. Countries manage this through their own national ‘registries’ which are required to be validated and monitored for compliance by the UNFCCC[5]. Each operator has an allowance of credits where each unit gives the owner the right to emit one metric ton of carbon dioxide or other equivalent greenhouse gas. Operators that have not used up their quotas can sell their unused allowances as carbon credits, while businesses that are about to exceed their quotas can buy the extra allowances as credits, privately or on the open market. As demand for energy grows over time, the total emissions must still stay within the cap, but it allows industry some flexibility and predictability in its planning to accommodate this.

By allowing allowances to be bought and sold, an operator can seek out the most cost-effective way of reducing its emissions, either by investing in ‘cleaner’ machinery and practices or by purchasing emissions from another operator who already has excess ‘capacity’.

Since 2005, the Kyoto mechanism has been adopted for CO₂ trading by all the countries within the European Union under its European Trading Scheme (EU ETS), with the European Commission as its validating authority [6]. From 2008, EU participants must link with the other developed countries that ratified Annex I of the protocol and trade the six most significant anthropogenic greenhouse gases. In the United States, which has not ratified Kyoto, and Australia, whose recent ratification comes into force in March 2008, similar schemes are being considered.

### Green Credits

A special class of quasi-financial derivative products including production credits and offset (reduction) credits and emission allowances for emissions and energy processes as a mechanism mainly to improve environmental quality and energy efficiency through defining and then trading for cash or consideration in various aspects of environmental or energy commodities, production or use, including air emissions reduction credits like NOx, SOx, CO₂, and CO₂e (carbon dioxide, methane, nitrous oxide, sulfur hexafluoride, hydro fluorocarbons, and per fluorocarbons), as well as others, energy credits like Renewable Energy Credits (REC's) of various forms (i.e., wind, solar, geothermal, etc.) for producing electricity, and white tags (energy efficiency credits/energy use reduction credits). “Green credits” include the full range of environmental or energy credits (that now exist or may come into existence in the future) related to clean water, clean air, emissions reductions, reduction of pollutants, improved land or water use, or water rights, as well as other categories of energy and power.

Accordingly, the term “green credit” includes, without limitation, the terms “credit,” “carbon credit,” “certified credit,” and “emission allowance” or “allowance” and may be taken as interchangeable therewith in this document and includes specific credits (Kyoto Protocol CDM market), as well as their corresponding forms in relation to any credit, whether they are described here in specific or general terms.

### Green Credits Certifying Body

Any entity that certifies green credits, including a regulatory agency of some type according to set rules, or an independent or industry certification agency having set rules or standards, or, in the case of a “voluntary” market, the company developing the credit, or any combination thereof.

### Green Project

Any project designed to produce a result for which green credits (including emission allowances) can be granted.

### Integrated Software Platform (Platform)

Workflow software, including lifecycle modules, by which analysis, calculation, preparation, documentation, data management, workflow management, trading and storage of green credits are directed and managed.

### Lifecycle

The various steps and transactions in a green credit certifying process.

### Master Project Document (MPD)

A document (including an electronic document) required by a green credits certifying body as part of its green credit certification process containing information concerning the design, development and/or implementation of a green project including the effectiveness of its methodology and its anticipated results.

### Module (Lifecycle Modules)

The software that manages and directs one or more lifecycle transaction(s) or functions.

### Offset or Reduction Credits

A property right to the certified reduction of use or reduction of production of a particular commodity (like electricity use, or NOx pollutants, or carbon). In offset credits, the credit is often measured in terms of “commodity NOT produced as measured against a predefined baseline (benchmark) (defined either system-wide, project-wide or internally).

### Participants or Contributors

Individuals or agencies that participate in or contribute to the lifecycle process of the creation, validation, certification and settlement of green credits including buyers and sellers.

### Preliminary Master Project Document (PMPD)

Any interim document preliminary to, but eventually leading to, a master project document.

### Production Credits

The production of a particular commodity (like electricity) using a specific methodology or resource (like renewable power in general, solar or wind resource in particular). The credit itself tends to refer to the “strip” or designated part of the commodity (or electrons) related to the methodology or resource and generally is “detachable” from the commodity itself. For example, a “REC” is essentially a certified contract that defines renewable property rights of a particular electricity commodity. In production credits, the credit often is measured in simple terms produced.

### Project Lifecycle Process (Lifecycle, Lifecycle Process (PLP))

The various transactions involved in the creation of certified green credits, typically including communications and/or interactions with and between project designers, project developers, validators, government agencies and financial institutions.

### Project Methodology

The physical mechanisms by which green projects abate or reduce adverse environmental conditions (production or reduction).

### Template

One or more data fields presented on a computer screen into which specified data (structured and/or unstructured) can be entered.

### Workflow

The paths taken by various information components including, without limitation, documents, electronic communications (i.e., e-mail), calculations, and other data in the Lifecycle Process.

### BACKGROUND OF THE INVENTION

There has been a significant increase in recent years in the creation, development and trading of a special class of quasi-financial derivatives products, referred to herein as “green credits,” related to the production and offset (reduction) of emissions and energy processes. Green credits provide an economically viable mechanism to improve environmental quality and energy efficiency.

Green credits can be earned for: (1) the reduction of air emissions such as NOx, SOx, CO₂, CO₂e, and the like; (2) the creation of renewable energy sources (Renewable Energy Credits or RECs) of various forms (wind, solar, etc.) for producing electricity and other forms of energy; and (3) the reduction of the use of energy for a given activity (sometimes referred to as energy efficiency credits or energy use reduction credits or white tags). It is foreseeable that, in the future, green credits will include a wide range of environmental or energy activities related to clean water, air, emissions, pollutants, land or water use, or water rights or various categories of energy or power.

In general, “production credits” tend to involve the production of a particular commodity (like electricity) using a specific methodology or resource (like renewable power in general, solar or wind resource in particular). The green credit itself tends to refer to the “strip” or designated part of the commodity (or electrons) related to the methodology or resource and generally is “detachable” from the commodity itself. For example, a “REC” is essentially a certified contract that defines renewable property rights of a particular electricity commodity. In production credits, the credit often is measured in simple terms of the commodity produced.

“Offset” or “reduction” credits tend to involve a property right to the certified reduction of use or reduction of production of a particular commodity (e.g., electricity, or NOx pollutants, or carbon). Offset credits are often measured in terms of “a commodity NOT produced” as measured against a predefined production baseline (which can be defined either system-wide, project-wide, or internally).

For a production project, the product (e.g., electricity) may be for a regulated and compliance driven market, in which case, the credit is generally defined by a regulatory agency of some type according to set rules. Where the product is for a “voluntary” market, the credit is generally defined either by the company developing the product or by an independent or industry certification agency. The same is true for a reduction project.

Credits can be earned for a “non-physical” portion or strip of the commodity being produced or reduced in that they cannot be physically separated for delivery from the commodity (e.g., in the case of RECs or white tags), whereas, in the case of reductions in emissions or pollution, the credits are given for a measured amount of a physical commodity such as CO₂ (a gas) or particulate matter or mercury (a solid) that can be physically captured or removed from the commodity stream, or a non-physical version of that commodity (use of less of the commodity, for example, would not physically separate or sequester the strip, but would reduce the strip). The credit earned is often based on a measured volume, weight, time, kwh, or some other measurable output. Credits earned can also be measured in terms of time of production or reduction, e.g., 10,000 tons of CO₂ over five years.

The present invention pertains to those green projects where, in order to earn credits, the project must be certified by a process that requires the submission of a project document to an oversight certification agency. Such an agency may be independent, governmental (international, national or state), voluntary or regulated and subject to a registry or inventory of some sort. The invention is independent of the jurisdiction of the certifying agency or agencies. The credit value of a submitted project may be measured against itself, internally defined targets, past targets or externally defined targets and often includes some combination of qualitative and quantitative engineering or scientific, economic, business and narrative information. This submitted project document is generally referred to as a master project document (MPD) and will be so nominated herein (the Kyoto parlance for this equivalent document is PDD—project design document). Any document related but preliminary to a MPD is referred to as a preliminary master project document (PMPD).

It is typical in a green credit certifying lifecycle process for there to be some measure of auditing, validation and/or certification required (even if it is self-reported) and, in some cases, post production or ongoing verification and monitoring is required. FIG. 1 illustrates some basic steps in a typical lifecycle for certifying green credits for a carbon project by a certifying agency (e.g., under the mechanism of the Kyoto Protocol). The certifying process is geared to insure that the earned credit represents a real environmentally positive activity (although the meaning of the term “certified” can vary widely and may include “self-certified”). In the example of a carbon abatement project, the project design includes a carbon assessment of the tons of carbon to be abated and a feasibility assessment of reaching that target. During the design phase, it is often required to benchmark the results of various calculations and projections to determine how the project metrics compare to other projects green projects. Once the project design is completed and freely documented in the MPD, it is typically submitted to various participants for validation and registration or approval, including an auditor, certifier, or validator, an approval body, such as the CMD Executive Board under the Kyoto Protocol's Clean Development Mechanism, the country where the project is to be implemented and any other certifying agency involved. Once the project is approved and implemented, it is monitored to verify its performance and calculate its actual performance on which the green credits (carbon, in this case) are issued. The monitoring and verification can be an ongoing process.

An up and running example of the commerce of certified credits and carbon credits is the carbon credit or CO₂ market developed under the Kyoto Protocol, which includes as one of its markets the Clean Development Mechanism (CDM).

The Kyoto Protocol (1997) helped create the Clean Development Mechanism (CDM) which allows developing nations such as India and China to sell any reductions of carbon emissions (and other greenhouse gas (GHG) emissions measured in CO₂ equivalents) achieved in a development project (compared to 1990 baseline) to a developed nation (like UK, Netherlands) at a market-set commodity price (as of Aug. 18, 2006 at $15/metric ton of CO₂e). Increased prices and future volatility of fossil fuels, increased awareness and acceptance of the negative impact of carbon emissions and an increased emphasis on renewable energy—all have created a $10 billion global market for trading with over 130% growth from 2004-2005 and over 374 million tons of CO₂e traded in 2005.

In order to create such a certified carbon credit, the project developer (company or government agency) must first design, develop and implement a CO₂e reduction or abatement project and, as part of the process, prove that its methodology is effective and that the project will and does abate a certain amount of CO₂e. To facilitate the process, the United Nations has set up a regulatory body, the CDM Executive Board, to certify the credits and define the credit creation and validation process.

Under the CDM established protocol, carbon credits for a given development project (e.g., installing a wind farm in China) are released to the seller after following a mandated project lifecycle process.

Currently, following the CDM mandated lifecycle process to satisfy the transactional infrastructure for receiving carbon credits is highly fragmented (see FIG. 1) and non-standardized and, as a result, very expensive and protracted (12-18 months). Further, documentation necessary through the entire process—touching multiple entities—is not easily available, is not standardized and is not very securely handled in the transactions. Also, the front-end of the process (e.g., the project design) includes quantitative scenario planning for optimizing the carbon credit return on the project investment which is currently done in an ad hoc manner by independent, for-profit consulting firms. The lack of standard practices and unified records creates significant difficulties in complying with the demands of the certification processes which is a significant part of the carbon credit certification lifecycle. The resulting long delays due to this inefficiency cause significant time-to-market costs for project developers—forcing them to initiate fewer projects per year and, thus, slowing the rate at which environmentally positive projects come on line.

### BRIEF DESCRIPTION OF THE INVENTION

The process of calculating the reduction or abatement of carbon, for example, from a given green project is complex and depends on a number of calculations based on data such as current carbon baselines (benchmarks) (i.e., the amount of carbon displaced to produce a kilowatt of electricity in a particular location, or the amount of carbon displaced in producing a kwh of electricity using the project methodology), local conditions, historical events, all relative to a particular methodology. In addition, under the Kyoto Protocol, approved methodologies incorporate the standards for each particular type of project to be measured against—complicating the analysis.

Types of projects under the EU Trading scheme:

Electricity generators

Heat and Steam

Mineral Oil Refineries

Ferrous metal production

Minerals—cement, glass and ceramics

Pulp & Paper production

Types of projects under the CDM scheme:
Projects where methodologies have been approved.

HFC destruction projects

Stranded gas projects

Methane capture projects

Landfill gas to energy projects

Sink forestry projects

Fuel switching projects such as coal to gas conversions

Renewable energy projects: wind, solar

Future projects methodologies waiting approval:

Transport projects

Housing projects

Energy efficiency projects:

Demand management

Thus, in order to fairly and accurately assess a project at any stage from design to validation to implementation to monitoring its performance, it is highly advantageous to have easy access to the data and calculation algorithms used at any one stage at every other stage of the project lifecycle. It is equally advantageous to be able to benchmark any calculation or analysis with reliable and verified comparable data. At the present time, this is not the case and no system or procedure has been developed, prior to the present invention, which permits the ease of transparency provided by the present invention.

The present invention provides a web-based computer system and, more particularly, a system that enables and provides a more transparent, accurate, precise, economic, efficient and effective lifecycle process for the creation and certification of green credits (production or offset) of any type, primarily related to the energy and environmental credits described above. Thus, while the overall system of the present invention and its novel components are, in some cases, described and illustrated in conjunction with the creation of certified carbon credits, it will be understood by those skilled in the art that the system described is equally applicable and adaptable to other credit schemes mandated by other agencies instituted to improve environmental quality and energy efficiencies.

The system of the present invention provides a multi-user, web-based computer software automated workflow engine (platform) that standardizes, records and implements the workflow in the lifecycle process for creating a green credit including its registry and trading.

The primary lifecycle steps or phases that are typically required for projects claiming carbon credits and that are facilitated by the present invention include: (1) project design, including carbon impact assessment and feasibility assessment; (2) one or more independent approvals, typically by one or more governmental agencies and/or industry agencies; (3) verification of actual results, all with benchmarking capability; and (4) inventory or emissions measurements. Other steps and sub-steps will typically be necessary in a lifecycle process creating carbon credits or offsets, depending on the particular methodology (i.e., type of project such as wind farm or biomass, etc.), certifying agency, trading agency and governmental institution. These sub-steps are also facilitated by the present invention.

The system of the invention provides secure Internet or intranet accessible software modules for project designers, developers, validators, government agencies and financial institutions to transact with the system in a systematic and time-efficient manner per the project workflow lifecycle. These modules allow the invention to:
1. Provide a detailed e-Record of the entire transaction—at any place and at any time in the transaction—in a secure manner;
2. Provide the analytics that allow various supply chain partners, especially the project designers, to make quantitative decisions; and
3. Own the settlement infrastructure that is used to provide the royalty for the various participants when the carbon credits are awarded.

The system of the present invention provides a collaborative automated workflow engine module by which a plurality of participants can work together to design a project and, in the process, record data according to a template that automatically creates a standardized e-Record useful to implement and facilitate not only the project design, but also the necessary workflow transactions that come after the project design has been set and approved. The workflow engine module provides communicative links with the participants and between participants.

To initiate a carbon credit lifecycle process for the certification of carbon credits, the present invention provides a web interface where a new project account is created by providing required basic information such as a general description of the project, its owner, participants, etc. The project is assigned a unique project identification code (PIC) that it carries throughout the lifecycle process and is used to identify the data in the e-Record specific to that project.

The creation of a master project document (MPD) is then initiated by an authoring tool, with the software of the invention providing drop-down menus, selectable fields and other known ways of prompting and entering data. For example, the methodology of the project (wind farm or conversion to biofuels, etc.) is selected from a drop-down menu that includes scores of methodologies approved by CDM and other certifying bodies.

Once the project methodology is selected, the invention workflow platform software automatically makes available at the computer screen of the user a series of e-Record templates for that methodology that initially guide the developer in disclosing and verifying the project design and, where required, assisting in the design process itself. By requiring that each project be disclosed according to a standardized format, the data from different contributors to a single project is stored in the e-Record and identified with only that project through the PIC. In addition, the standardization makes possible the ready comparison of different projects stored in the e-Record. The templates presented to a user of the present invention present fields into which structured (numbers), semi-structured (maps, charts, etc.) and unstructured (words) data can be entered. These templates are specifically designed to call forth data and information that reflect the requirements and standards set by the particular agency from which the credit is requested. The invention contemplates that the available templates will be specific not only to multiple methodologies, but multiple certifying agencies, as well.

Data is entered into the templates in “element” units where each “element” is the data entered into a given field. Multiple elements can form “sections.” An important feature of the invention is the requirement that each data element be tagged as to source (which can be as simple as a reference to the source and as complete as a link to the source itself), date entered and permission (identification of those who can have access). Any data element not so tagged is automatically tagged as “unsourced.” The elements can be nested so that permissions can be used to limit the accessibility of certain data including to its source.

The invention requirement that data be sourced greatly facilitates the design phase by allowing contributors to the design to share information with confidence and with the ability to cross-verify vital data and information. It also greatly facilitates the approval/certification phases by permitting those charged with evaluating the project to have ready access to the base data. Any questions concerning the premises on which the credits are based can be quickly checked and verified. Where the source of critical elements is missing or questionable, these areas can be readily identified and questioned.

One of the modules of the system of the invention is a metrics data module that includes recognized reliable data relative to a variety of methodologies that can be used benchmarking by the project designers, the project validators and anyone else who has a role in the lifecycle process for certifying or trading the credits. This benchmarking tool draws data from the metrics database which can include the e-Records of other completed projects, including the verification of actual results, as well as other recognized sources of relevant and reliable data. This module provides those participants involved in the design and certification process with ready access to meaningful data by which calculations and projections can be judged.

Another system module stores and makes available best practices analytics and algorithms so that there is uniformity in the analytic approaches by those charged with assessing the value and effectiveness of the project and, when better analytic approaches appear in the e-Record, they can be imported into this analytics module.

The approval step or steps that follow the project design are also conducted according to system templates designed to complement the design phase and automatically import data from the e-Record created during the design phase and can result in feedback by which design elements are modified, added or eliminated.

Thus, the platform of the invention includes various modules that provide templates that guide and record the project design in an organized, standardized manner that streamlines all phases of the lifecycle process and also facilitates the project design; a collaborative engine module through which multiple contributors in far-flung locations can work as a team; one or more modeling modules by which calculations and analytics can be performed according to accepted algorithms; a data module providing reliable data for use by the modeling modules and to facilitate benchmarking; and an e-Record module that records and makes available all of the data in the MPD and the PMPD, including the algorithms and data used to make calculations, as well as all electronic communication between the participants. The data provided by the project owner is protected at all times through a secure permissioning protocol by which data in the e-Record is released only to those with a need to know and only as allowed by the project managers.

These and other aspects and features of the present invention will be better understood from the following detailed description of the preferred embodiments when read in conjunction with the appended drawing figures.

### DESCRIPTION OF THE DRAWINGS

FIG. 1 is a diagram of a typical workflow in the green credit certification process;

FIG. 2 is a schematic diagram of the system of the present invention;

FIG. 3 is a schematic diagram of the contents of the metrics database of the system of FIG. 2;

FIG. 4 is a schematic diagram illustrating the relationship between the e-Record of the system of FIG. 2 and other modules and functions of that system;

FIG. 5 is a schematic diagram illustrating the data flow connections between various modules and functions of the system of FIG. 2;

FIG. 6 is a schematic diagram illustration yet other relationships similar to those shown in FIG. 5;

FIG. 7 is a schematic illustration of the flow of data between a project manager and a validator;

FIG. 8 is a schematic illustration of the flow of data between a validator, a regulator, project manager and registry;

FIG. 9 is a schematic illustration of the template databases of the system of FIG. 2;

FIG. 10 is a schematic illustration of a data tag; and

FIG. 11 is a flow diagram showing the flow of information used to assemble a document such as a MPD.

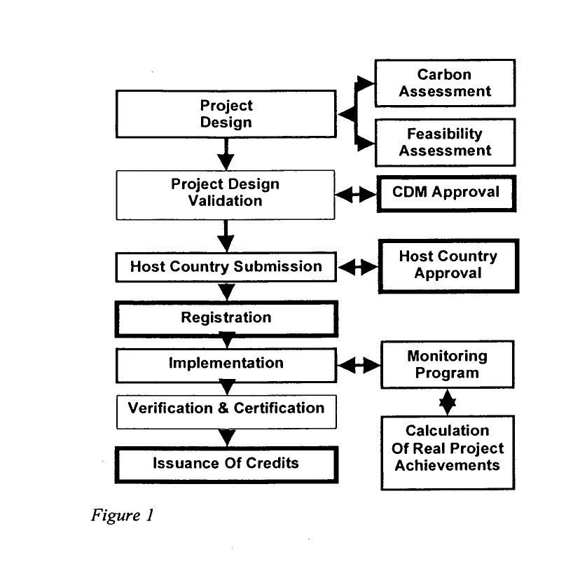

### DETAILED DESCRIPTION OF THE INVENTION

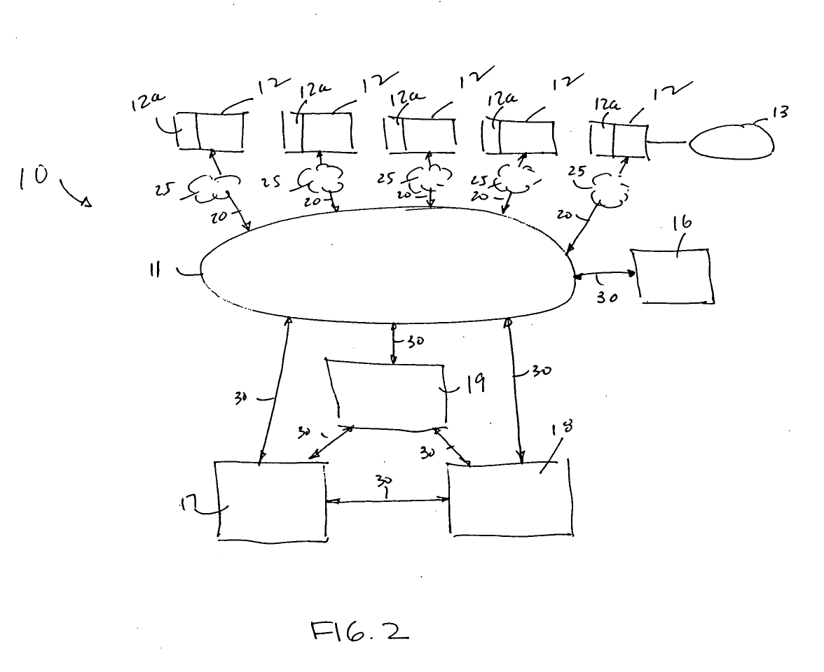

Referring to FIG. 2, the system 10 of the present invention includes an automated web-based workflow collaboration engine 11 (platform) sharing certain data and materials, calculations and functionality with user-defined permissions directly among various participants 12 having access to the system 10 via the Internet (or intranet) 25 and individual portals 20 using computers 12a. The participants 12 in the document preparation and credit creation lifecycle process can include, by way of example, credit owner, project manager (designer), monitor, validator, verifier, and certifier in creating a certified credit 13, as well as those involved in the trading (buying and selling) and ongoing monitoring process. In the course of the lifecycle process, the engine 11 creates and makes available a secure, detailed and auditable electronic record trail, e-Record 16, of the documentation, data, participant communications and calculations used for project design, validation, certification and settlement of credits 13. The system 10 further includes a calculation module 17 that performs analytics and calculations to determine and/or compare the effectiveness of various project metrics and a credit calculation module 18 that performs analytics and calculations to determine the carbon credits the project will produce. A metrics database s 19 stores energy, materials and emissions data for use by the calculation modules 17 and 18, permitting them to perform the workflow tasks mentioned above including benchmarking. The platform 11, modules 17, 18, and 19 and e-Record 16 are all interconnected by data connection links (data flow paths) 30. It is to be understood that the designation and representation of modules 17, 18 and 19 as individual units is artificial and that the modules represent functions more than separate physical objects. The modules 17 and 18 are, in essence, databases of algorithms used to make calculations for given situations using data from metrics module 19. The modules 17 and 18 may be general or specific to a given market mechanism (e.g., JI or CDM) and/or specific to a particular methodology in a market incorporating a portion of preset elements of the methodology.

The module 18 is used to calculate certified green credits (e.g., CO₂e reduction credits) in the same platform as a web-based module 17 for calculating the abatement or reduction abatement (i.e., the reduction of CO₂e use from implementation of a particular project to the particular standards, e.g., Kyoto CDM or JI). The calculation module 18 stores and can make available reliable and accepted lifecycle analysis (embedded) methods for calculating emissions or energy content “upstream” or that which is included or embedded in the production or manufacturing of components, inputs or subsystems to the project being measured. The modeling module 18 advantageously includes best practices analytics so that there is uniformity in the analytic approaches by those charged with assessing the value and effectiveness of the project and, when better analytic approaches appear in the e-Record, they can be imported into module 18.

The modules 17 and 18 enable rapid scenario modeling of the green project's quantitative results, according to various rules of the various certifying systems, making it useful in the design stage to both test the feasibility of the project and maximize the green credit return. In the case of carbon credits, for example, most general parameters of CO₂ reduction projects are well known (i.e., capital costs, energy savings, energy costs, feedstock costs, market value of certified carbon credits, etc.). Thus, these parameters are advantageously stored in database metrics module 19 and made available modules 17 and 18 as required.

Information in the MPD in e-Record 16 determines the algorithms used by modules 17 and 18, as well as the data imported into those modules from metrics module 19.

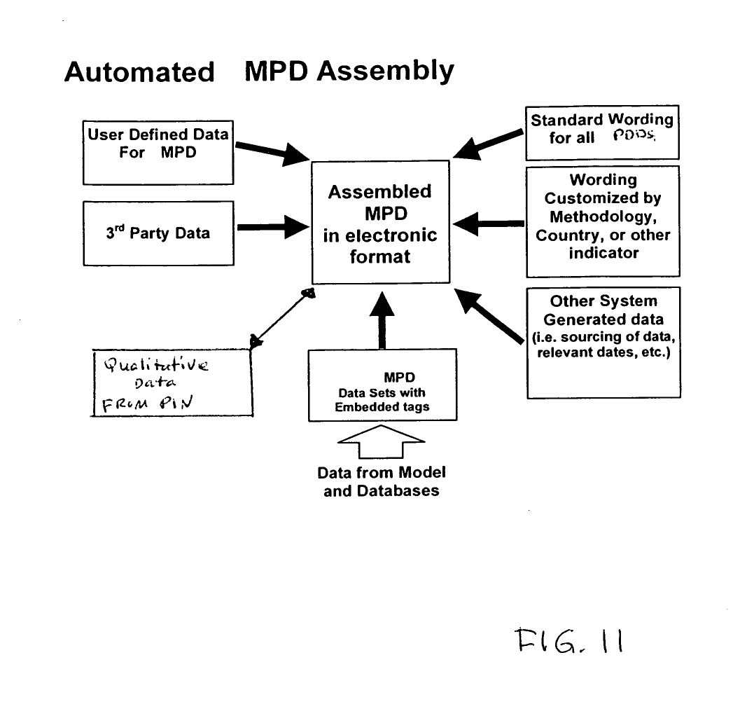

In practice, the calculation module 18 receives input data from the e-Record 16 including the methodology, the certifying agency and all of the other data specific to the subject project that the module 18 uses to establish a model framework. A “wizard” then rapidly builds a specific model for a proposed or actual green project based on user-chosen, system set, predefined methodologies, pre-integrated, plus user-defined data from metrics database 19 and predefined calculations and predefined document-specific workflow by credit type (CO₂e credits) and market type (CDM, JI, California) and, most importantly, source tags (see FIG. 10) detailing the predefinitions used. For example, significant generic modeling tools for calculating emissions offset and energy usage exist in the market—however, the present invention relates to these modeling tools, with specific sub-models included for each methodology in a given mechanism (for example, each approved methodology for certified emissions reductions under Kyoto CDM), where the model input mechanisms are based directly and solely on the methodology and deviation is not permitted without tagging in the source tags and alerting the user/regulating agency/auditor. Prior to the present invention, no such sub-model modeling tools existed that were integrated into any workflow system.

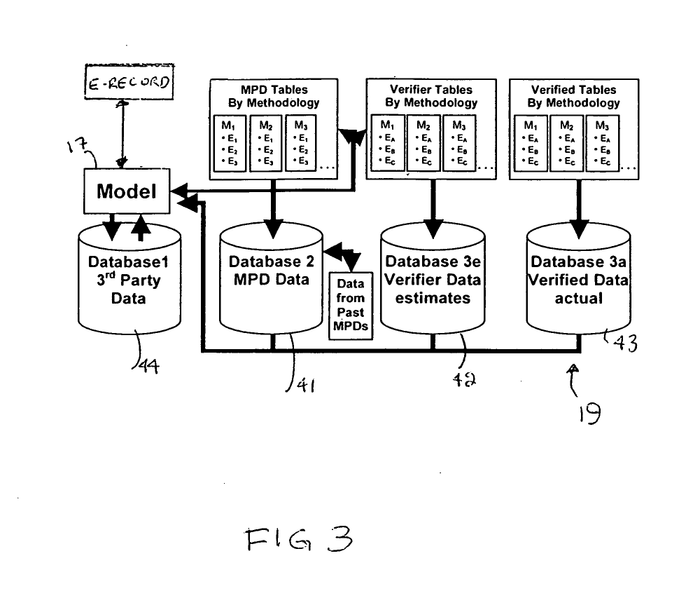

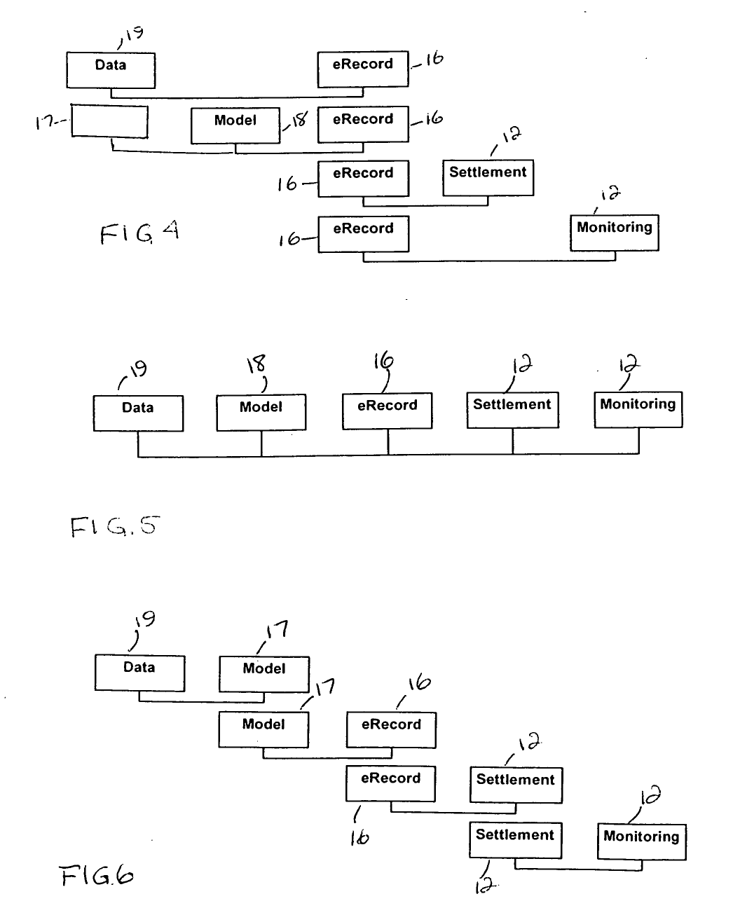

FIG. 4 illustrates the e-Record 16 functionally linked to (has a flow path with) the calculation modules 17 and 18 and metrics module 19 so that data can flow in both directions such that the e-Record 16 stores outputs from the modules 17 and 18 and provides the modules with the data necessary to select the algorithms appropriate to make the required calculations for a given methodology and location. One of the outstanding features of the invention is that the e-Record records the calculations made by the modules 17 and 18, the data from module 19 supplied in making those calculations and the algorithms used by the modules in making the calculations.

FIGS. 4 and 5 illustrate other advantageous functional connections between the various elements of system 10 by which information from the e-Record 16 is made available.

One of the advantages of the invention for carbon credit creation and trading flows from the incorporation of the combination of the multi-party workflow engine 11, analytics/calculation modules 17 and 18, and metrics database 19 (providing energy, materials and emissions inputs) in the same system 10.

Referring to FIG. 3, in the preferred embodiment, the data module 19 is composed of a number of data sources, some of which are dynamic in that they are constantly being updated. These data sources can include data from the MPD in the e-Record 16 of the project in question (user data), algorithms based on methodology, verified data for different methodologies, data from actual monitored projects, data from other MPDs with verified data tags, industry recognized engineering and financial data, etc. By way of example, database 19 can advantageously include such various sources of data relevant to the calculations and analysis performed by modules 17 and 18 as: data 41 from the e-Records of other green projects; data 42 from project performance estimates that have been verified but not yet been proven in actual project performance; data 43 from the actual performance of projects including associated projects estimates; and third party data 44 (i.e., industry recognized energy, materials and emissions inputs data). Each of the aforementioned data sources is advantageously categorized and selectable by methodologies, certifying agencies and physical locations. Database 44 includes parameters that are user-defined, as well as some industry standards, all preferably with integrated, independently verified sources of the standard data and preferably with system requirements to identify which user-defined data has sources attached. All of the data in database 19 is made available to the modules 17 and 18 and the platform 11 (see FIG. 2) and can be updated from those sources as well, as indicated by the data flow lines 30. The database 19 allows the design and certification workflow process to have immediate access to highly relevant data for use in making any number of necessary calculations including benchmarking.

Part of the workflow between the system 10 and each participant 12 includes: template-based submission publication of various documents; data and file sharing; submission comments management and integration of comments into the e-Record 16; document authoring tools; and permissions control.

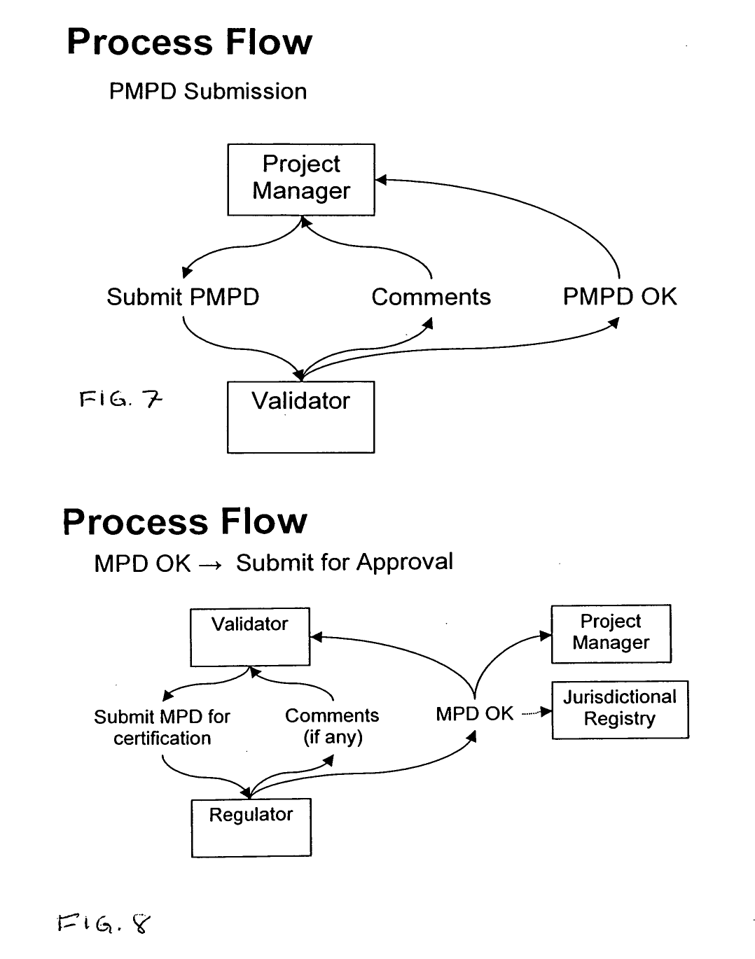

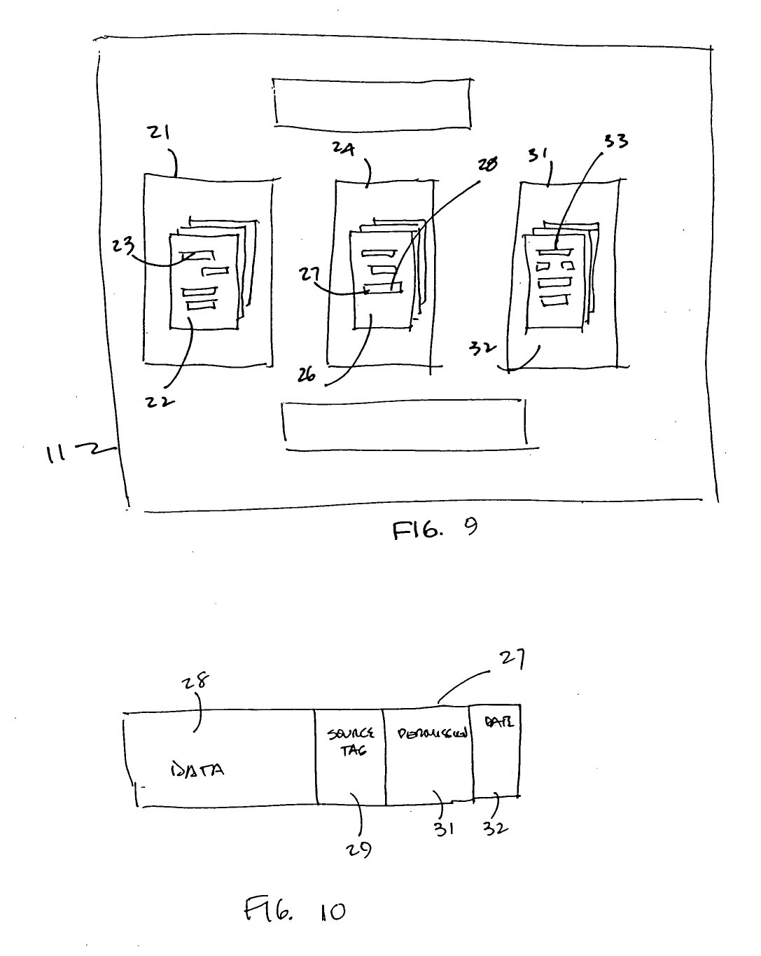

Referring to FIGS. 7 and 8, the system 10 enables the flow of information between participants such as the project manager and a validator. When the MPD, for example, is submitted to the validator, the validator, having access to the e-Record 16, is able to quickly know what calculations were made, what algorithms were used, what data was employed and to make comments specific to those items. This lends itself to a much quicker approval. The same holds for the submission of the MPD by the validator to the regulator, as everyone is using the same basis for making their evaluations or knows they are not. The system 10 can be attached to an electronic trading platform permitting auction, trading and settlement.

The system 10 can be integrated with a third party registry or “inventory” of total jurisdictional credits, commodity production or trades.

By way of example, the invention provides the following advantages for the Kyoto CDM Carbon Credit Market:
Online workflow environment;
Browser-based access, ASP delivery;
Access specific to each party, e.g., project designer, modeler, validator, regulator, verifier;
User access control and privileges;
Internal messaging and alerts to distributed team;
Online virtual meeting, presentation, file sharing and instant messaging;
Online creation and management of PIN, PDD, legal contracts;
Multi-user collaborative document creation tools, file sharing and version control;
File sharing user authentication and access alerts;
Audit trail of all documentation and modeling activity;
Summary reporting on audit trail;
Separate workflow environment for regulatory and verifier review;
Rapid scenario modeling of CO₂e calculations;
Integrated project management/file management systems;
Full workflow integrated into the database and model; and
Auditable e-Records of all documentation and data.

Referring again to FIG. 2, the system 10, as explained above, at a system level, provides an integrated automated software workflow platform 11 that, together with other components, facilitates and standardizes the analysis, calculation, preparation, documentation and data management, workflow management, trading and storage of certified emissions and energy credits 13 or offsets (green credits), and communications with various participants 12. The system 10 includes communication links between platform 11 and participants 12, as well as with each other, by way of computers 12a that connect to the platform 11 through the Internet 25 (or an intranet) in any one of several well known modalities. The invention contemplates that the various parties will communicate with the platform 11 through separate and distinct web-based portals 20. In the course of the design and certification of a given green project, data is entered into the system 10 by way of workflow platform 11 for that project and is stored in an e-Record 16 with a unique identifier (code) that enables the data for a particular project to be retrieved and viewed separately. The e-Record 16 is accessible during the entire workflow lifecycle to implement and facilitate not only the project design, but also the necessary workflow transactions that come after the project design has been submitted.

The core project information in an e-Record 16 is based on a master project document (MPD) and preliminary master project document (PMPD) (as an example, a project design document (PDD) or project information note (PIN) in the Kyoto CDM market rules) and is a traveler following a project from conception, and along the way, incorporates all of the information, records, data, analytics, sources and communication that take place during the documentation and certification workflow of a green credit. This e-Record is advantageously held “third party” from each of the participants, allowing the provision and publication of appropriate portions of the information, as well as meta data and/or aggregations of that information to various parties in the process, both prior to and during creation of the green credit, as well as during the trading and post monitoring process. Third party maintenance of the e-Record assures confidentiality in the process and enables use of the system to achieve greater efficiencies and reliability.

The workflow platform 11 contains a number of template databases that facilitate the workflow lifecycle by standardizing the form and content of data submissions. When selected, each template presents to the user at his/her computer screen a form with various fields into which specified information and data is to be entered. Drop-down menus, selectable fields and other known ways of prompting and entering data can be used to facilitate the data entry process.

Referring also to FIG. 9, the workflow platform 11 includes a registration template database 21 containing one or more registration templates 22 having a plurality of fields 23 designed to elicit basic project information such as the identity and contact information of the project sponsor, the project managers, the methodology of the project, the location of the project, the certifying agency and the like.

To initiate a carbon credit lifecycle process for the certification of carbon credits and create a new project account, the information requested in a registration template 22 is entered by or on behalf of the project sponsor. Once completed, the project is assigned a unique project identification code (PIC) that it carries throughout the lifecycle process and is used to identify all data entered on behalf of that project in the e-Record 16.

A workflow template database 24 includes a plurality of workflow templates 26 corresponding to different methodologies (e.g., wind farm or conversion to biofuels, etc.) and different agencies (e.g., CDM). Thus, for each project, there is a workflow template 26 corresponding to a particular methodology and certifying agency whereby the data required by that agency for that methodology is elicited by fields 27 in templates 26. Once the basic data called for by registration template 22 is entered, the workflow templates 26 corresponding to that project's methodology and certifying agency are selected and made available to the project sponsor to guide the entry of required data in a standardized format for the creation of a master project document (MPD).

The templates 26 initially guide the developer in entering into data fields 27, data elements 28 that disclose and verify the project design and, where required, assist in the design process itself by use of the modeling modules 17 and 18 and metrics module 19 (see FIG. 2). By requiring, for the most part, that data be input according to a standardized form and format, projects similarly identified in the e-Records 16 can be more readily understood and benchmarked. The data elements 28 in fields 27 can include structured data (numbers), semi-structured data (maps, charts, etc.) and unstructured data (words). Templates 26 are specifically designed to call forth data and information that reflect the requirements and standards set by the particular agency from which the credit is requested. The invention contemplates that the available templates will be specific to not only multiple methodologies, but multiple agencies, as well.

Referring also to FIG. 10, data is entered into the workflow templates 26 in “element” units 28 where each “element” is the data entered into a given template field 27. Multiple elements 28 can form data “sections.” An important feature of the invention is the requirement that each data element 28 include a source tag 29 (which can be as simple as a reference to the source and as complete as a link to the source itself), a permission tag 31 (identifying those who can have access to that data element) and a date tag 32 specifying the date when the element was entered and/or updated in the template field 27 and e-Record 16. Those skilled in the art will recognize that other information can be included in tag 29. Data elements for which no source is provided can be automatically tagged as “unsourced.” Multiple elements 28 can be nested into sections so that permissions can be broadly stated to limit the accessibility of certain classes of data 28 including to its source tags 29.

The embodiment of the invention requiring that data be sourced (tagged) greatly facilitates the design phase by allowing all contributors to the design to share information with confidence that they are working with the same assumptions, calculations and data and with the ability to cross-verify vital data and information. It also greatly facilitates the approval/certification phases of the lifecycle by permitting those participants charged with evaluating the project to have ready access to the data used, its source and the calculations made by using the data. Any questions concerning the premises on which the credits are based can be quickly identified, checked and verified. Where the source of critical elements 28 is missing or questionable, these areas can be readily identified and questioned. As explained above, the system of the invention provides the ability of the various participants to communicate with one another from far-flung locations and to have transparent and standardized data with which to work.

A participant database 31 of participant templates 32 is accessible to and standardized to the interactions with lifecycle participants 12 such as project designers, developers, validators, government agencies, buyers, sellers and registry and financial institutions. In the preferred embodiment, for each necessary transaction in the lifecycle process, there are one or more templates 32 with fields 33 that guide the data input process by which the transaction data is recorded in a standardized format.

The approval step or steps that follow the project design are also conducted according to system templates designed to complement the design phase and automatically import data from the e-Record created during the design phase and can result in feedback by which design elements are modified, added or eliminated.

Thus, the invention provides templates and guides that record the project design in an organized manner that streamlines all phases of the lifecycle process, but also facilitates the project design itself by providing a collaborative engine through which multiple contributors in far-flung locations can work as a team. The data provided by the project owner is protected at all times through a secure permissioning protocol by which data in the e-Record is released only to those with a need to know and only as specifically allowed by the project managers.

FIG. 9 illustrates how an MPD is electronically assembled in platform 11 from the various inputs to platform 11. A PMPD is similarly assembled.

Of course, various changes, modifications and alterations in the teachings of the present invention may be contemplated by those skilled in the art without departing from the intended spirit and scope thereof. As such, it is intended that the present invention only be limited by the terms of the appended claims.

1. A computer-driven, web-based system that facilitates participants and workflow in a green credits certification process for a certifying agency for a green project having a methodology wherein the process may include the analysis, calculation, preparation, documentation, data management, workflow management, trading and storage of certified green credits comprising:
an e-Record database that records data from participants and is accessible to participants;
a web-based, participant accessible collaboration platform having a data flow path with said e-Record and including a database of different templates that guide the entry of data from participants into said e-Record;
a calculation database of algorithms having a data flow path with said platform and said participants for performing various calculations and analyses used in a green credit certification process; and
a metrics database storing data and having data flow paths with said collaboration platform and said calculation database and containing data useful for calculations and analyses made by the algorithms of said calculation database.

2. The system of claim 1 wherein said e-Record includes the master project document (MPD) for the green project being certified.

3. The system of claim 2 wherein said e-Record includes the MPD of one or more green projects other than the one being certified.

4. The system of claim 2 wherein said MPD includes data provided by participants through said collaboration platform.

5. The system of claim 1 wherein said calculation database includes algorithms that are specific to a plurality of different green project methodologies.

6. The system of claim 5 wherein said calculation database includes algorithms that are specific to a plurality of different green project certifying agencies.

7. The system of claim 5 wherein said calculation database has a data flow path with said e-Record.

8. The system of claim 1 wherein said collaboration platform includes templates that are specific to a plurality of different green project methodologies.

9. The system of claim 1 wherein said collaboration platform includes templates that are specific to a plurality of different green credit certifying agencies.

10. The system of claim 8 wherein said collaboration platform includes templates that are specific to a plurality of different green credit certifying agencies.

11. The system of claim 1 wherein said metrics database includes data from other operational green projects.

12. The system of claim 1 wherein said metrics database includes data from validated MPDs of other green projects.

13. The system of claim 1 wherein said metrics database includes data from a plurality of other green projects wherein said other green projects include a plurality of different methodologies.

14. The system of claim 1 wherein said e-Record includes the electronic communications between participants and said collaboration platform, between participants through said platform.

15. The system of claim 1 wherein said e-Record includes all calculations performed by said calculation database and all data from said metrics database used in those calculations.

16. The system of claim 1 wherein data from participants to said collaboration platform is source tagged to include the source of the data.

17. The system of claim 16 wherein any data not source tagged is automatically designated as “unsourced.”

18. The system of claim 1 wherein the MPD for the green project is assembled automatically by said collaboration platform from the data in the e-Record.

19. The system of claim 1 wherein the participants have access to said collaboration platform through individual web portals.

20. The system of claim 1 wherein said collaboration platform is in communication with a registry of green credits.
